SEQUENCE LISTING (2 sequences)

SEQ ID NO: 1 - DNA, 807 bp, Thermomyces lanuginosus
  CDS (1)..(807)
  mat_peptide (1)..()
gaggtctcgcaggatctgtttaaccagttcaatctctttgcacagtattctgcagccgcatactgcggaaaaaacaatgatgccccagctggtacaaacattacgtgcacgggaaatgcctgccccgaggtagagaaggcggatgcaacgtttctctactcgtttgaagactctggagtgggcgatgtcaccggcttccttgctctcgacaacacgaacaaattgatcgtcctctctttccgtggctctcgttccatagagaactggatcgggaatcttaacttcgacttgaaagaaataaatgacatttgctccggctgcaggggacatgacggcttcacttcgtcctggaggtctgtagccgatacgttaaggcagaaggtggaggatgctgtgagggagcatcccgactatcgcgtggtgtttaccggacatagcttgggtggtgcattggcaactgttgccggagcagacctgcgtggaaatgggtatgatatcgacgtgttttcatatggcgccccccgagtcggaaacagggcttttgcagaattcctgaccgtacagaccggcggaacactctaccgcattacccacaccaatgatattgtccctagactcccgccgcgcgaattcggttacagccattctagcccagagtactggatcaaatctggaacccttgtccccgtcacccgaaacgatatcgtgaagatagaaggcatcgatgccaccggcggcaataaccagcctaacattccggatatccctgcgcacctatggtacttcgggttaattgggacatgtctt

SEQ ID NO: 2 - protein, 269 aa, Thermomyces lanuginosus [sequence omitted]

(19) United States
(12) Patent Application Publication
(10) Pub. No.: US 2010/0298196 A1
(43) Pub. Date: Nov. 25, 2010

(54) ENZYME AND PHOTOBLEACH CONTAINING COMPOSITIONS

(76) Inventor: Neil Joseph Lant, Gosforth (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/850,962

(22) Filed: Aug. 5, 2010

Related U.S. Application Data
(63) Continuation of application No. 11/656,266, filed on Jan. 22, 2007.
(60) Provisional application No. 60/761,122, filed on Jan. 23, 2006.
(60) Provisional application No. 60/795,727, filed on Apr. 28, 2006.
(60) Provisional application No. 60/854,837, filed on Oct. 27, 2006.

(51) Int. Cl. C11D 3/40; C11D 3/395

(52) U.S. Cl. 510/301

(57) ABSTRACT

This invention relates to compositions comprising certain lipase variants and a photobleach and processes for making and using such compositions. Including the use of such compositions to clean and/or treat a situs.

### CROSS-REFERENCES TO RELATED APPLICATIONS

This application claims priority under 35 U.S.C. §120 to U.S. application Ser. No. 11/656,266, filed Jan. 22, 2007, which in turn claims priority under 35 U.S.C. §119(e) to U.S. Provisional Application Ser. No. 60/761,122 filed Jan. 23, 2006, U.S. Provisional Application Ser. No. 60/795,727 filed Apr. 28, 2006, and U.S. Provisional Application Ser. No. 60/854,837 filed Oct. 27, 2006.

### FIELD OF INVENTION

This invention relates to compositions comprising lipases and photobleaches and processes for making and using such products.

### BACKGROUND OF THE INVENTION

The appearance of lipase enzymes suitable for detergent applications gave the formulator a new approach to improve grease removal. Such enzymes catalyse the hydrolysis of triglycerides which form a major component of many commonly encountered fatty soils such as sebum, animal fats (e.g. lard, ghee, butter) and vegetable oils (e.g. olive oil, sunflower oil, peanut oil). However these enzymes typically showed weak performance in the first wash cycle and typically came with a malodor arising, it is believed, from hydrolysis of fats present in dairy soils like milks, cream, butter and yogurt. While not being bound by theory, it is believed that such soils are prone to lipase-induced malodor generation as they contain triglycerides functionalized with short chain (e.g. C₄) fatty acyl units which release malodorous volatile fatty acids after lipolysis. Even the when the performance of such enzymes was improved, the malodor issue remained. Thus, the use of this technology was severely limited.

We have found that the combination of a photobleach with certain lipase variants gives rise to an improved cleaning performance benefit, while minimising unacceptable malodor. Without wishing to be bound by theory, it is believed that the following mechanisms are likely to give rise to such benefits: improved stain removal of stains comprising carotenoid, anthocyanines, porphyrins, tannins and flavines materials, for example, curry, pepper sauce, tomato-based pasta sauces, coffee and tea, due to synergistic action between the lipase and photobleach; and the oxidation of the lipase enzyme, by the photobleach, post-wash, for example during the drying of the cleaned or treated situs thus leading to reduced malodor.

### SUMMARY OF THE INVENTION

This invention relates to compositions comprising lipases and photobleaches and processes for making and using such products.

### DETAILED DESCRIPTION OF THE INVENTION

### Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives and “stain-stick” or pre-treat types.

As used herein, the phrase “is independently selected from the group consisting of . . . ” means that moieties or elements that are selected from the referenced Markush group can be the same, can be different or any mixture of elements.

The test methods disclosed in the Test Methods Section of the present application must be used to determine the respective values of the parameters of Applicants' inventions.

Unless otherwise noted, all component or composition levels are in reference to the active level of that component or composition, and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

### Compositions

The compositions of the present invention typically contain from about 0.0001% to about 1%, from about 0.0002% to about 0.5%, or even from about 0.0005% to about 0.3% photobleach and from about 0.0005% to about 0.1%, from about 0.001% to about 0.05%, or even from about 0.002% to about 0.03% lipase.

Such compositions may take any form, for example, the form of a cleaning composition and/or a treatment composition.

The balance of any aspects of the aforementioned cleaning compositions is made up of one or more adjunct materials.

### Suitable Lipases

Suitable lipases include lipases selected from the group consisting of lipases having Enzyme Classification E.C. classification 3.1.1 and mixtures thereof. In another aspect suitable lipases include lipases selected from the group consisting of lipases having E.C. classification 3.1.1.3, as defined by EC classification, IUPAC-IUBMB. and mixtures thereof.

Examples of EC 3.1.1.3 lipases include those described in WIPO publications WO 00/60063, WO 99/42566, WO 02/062973, WO 97/04078, WO 97/04079 and U.S. Pat. No. 5,869,438. Preferred lipases are produced by Absidia reflexa, Absidia corymbefera, Rhizmucor miehei, Rhizopus delemar, Aspergillus niger, Aspergillus tubigensis, Fusarium oxysporum, Fusarium heterosporum, Aspergillus oryzea, Penicilium camembertii, Aspergillus foetidus, Aspergillus niger, Thermomyces lanoginosus (synonym: Humicola lanuginosa) and Landerina penisapora, particularly Thermomyces lanoginosus. Certain preferred lipases are supplied by Novozymes under the tradenames. Lipolase®, Lipolase Ultra®, Lipoprime® and Lipex® (registered tradenames of Novozymes) and LIPASE P “AMANO®” available from Areario Pharmaceutical Co. Ltd., Nagoya, Japan, AMANO-CES®, commercially available from Toyo Jozo Co., Tagata, Japan; and further Chromobacter viscosum lipases from Amersham Pharmacia Biotech., Piscataway, N.J., U.S.A. and Diosynth Co., Netherlands, and other lipases such as Pseudomonas gladioli. Additional useful lipases are described in WIPO publications WO 02062973, WO 2004/101759, WO 2004/101760 and WO 2004/101763. In one embodiment, suitable lipases include the “first cycle lipases” described in WO 00/60063 and U.S. Pat. No. 6,939,702 B1, preferably a variant of SEQ ID No. 2, more preferably a variant of SEQ ID No. 2 having at least 90% homology to SEQ ID No. 2 comprising a substitution of an electrically neutral or negatively charged amino acid with R or K at any of positions 3, 224, 229, 231 and 233, with a most preferred variant comprising T231R and N233R mutations, such most preferred variant being sold under the tradename Lipex®.

The aforementioned lipases can be used in combination (any mixture of lipases can be used). Suitable lipases can be purchased from Novozymes, Bagsvaerd, Denmark; Areario Pharmaceutical Co. Ltd., Nagoya, Japan; Toyo Jozo Co., Tagata, Japan; Amersham Pharmacia Biotech., Piscataway, N.J., U.S.A; Diosynth Co., Oss, Netherlands and/or made in accordance with the examples contained herein.

### Suitable Photobleaches

Suitable photobleaches include catalytic photobleaches and photo-initiators. Suitable catalytic photobleaches include catalytic photobleaches selected from the group consisting of water soluble phthalocyanines of the formula:

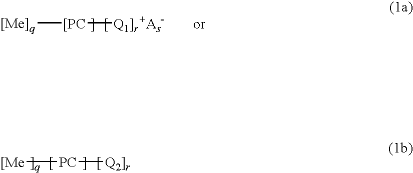

in which:
   PC is the phthalocyanine ring system;
   Me is Zn; Fe(II); Ca; Mg; Na; K; Al—Z₁; Si(IV); P(V); Ti(IV); Ge(IV); Cr(VI); Ga(III); Zr(IV); In(III); Sn(IV) or Hf(VI);
   Z₁ is a halide; sulfate; nitrate; carboxylate; alkanolate; or hydroxyl ion;
   q is 0; 1 or 2;
   r is 1 to 4;
   Q_{1,} is a sulfo or carboxyl group; or a radical of the formula —SO₂X₂—R₁—X₃⁺; —O—R₁—X₃⁺; or —(CH₂),—Y₁⁺;
      in which
         R₁ is a branched or unbranched C₁-C₈ alkylene; or 1,3- or 1,4-phenylene;
         X₂ is —NH—; or —N—C₁-C₅ alkyl;
         X₃⁺ is a group of the formula

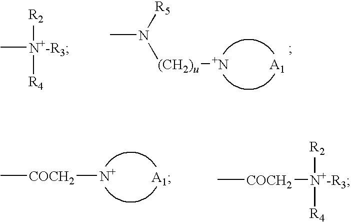

or, in the case where R₁═C₁-C₈alkylene, also a group of the formula

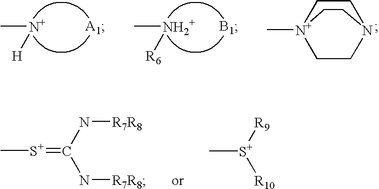

Y₁⁺ is a group of the formula

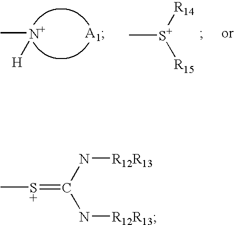

t is 0 or 1
   where in the above formulae
R₂ and R₃ independently of one another are C₁-C₆ alkyl
R₄ is C₁-C₅ alkyl; C₅-C₇ cycloalkyl or NR₇R₈;
R₅ and R₆ independently of one another are C₁-C₅ alkyl;
R₇ and R₈ independently of one another are hydrogen or C₁-C₅ alkyl;
R₉ and R₁₀ independently of one another are unsubstituted C₁-C₆ alkyl or C₁-C₆ alkyl substituted by hydroxyl, cyano, carboxyl, carb-C₁-C₆ alkoxy, C₁-C₆ alkoxy, phenyl, naphthyl or pyridyl;
u is from 1 to 6;
A₁ is a unit which completes an aromatic 5- to 7-membered nitrogen heterocycle, which may where appropriate also contain one or two further nitrogen atoms as ring members, and
B₁ is a unit which completes a saturated 5- to 7-membered nitrogen heterocycle, which may where appropriate also contain 1 to 2 nitrogen, oxygen and/or sulfur atoms as ring members;
Q₂ is hydroxyl; C₁-C₂₂ alkyl; branched C₃-C₂₂ alkyl; C₂-C₂₂ alkenyl; branched C₃-C₂₂ alkenyl and mixtures thereof; C₁-C₂₂ alkoxy; a sulfo or carboxyl radical; a radical of the formula

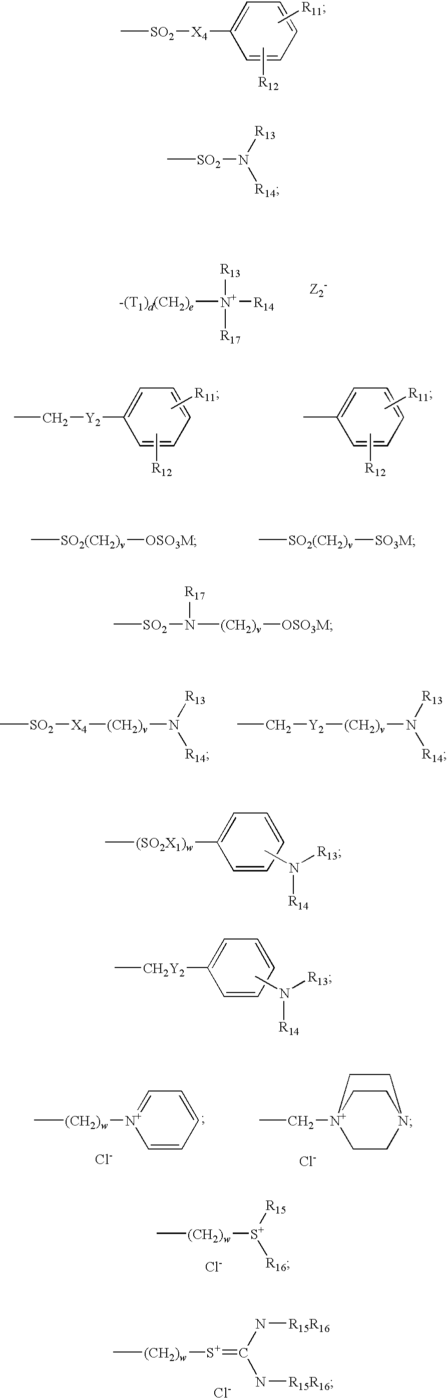

a branched alkoxy radical of the formula

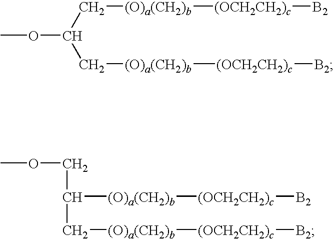

an alkylethyleneoxy unit of the formula

-(T₁)_{d}-(CH₂)_{b}(OCH₂CH₂)ₐ—B₃

or an ester of the formula

COOR₁₀
in which
B₂ is hydrogen; hydroxyl; C₁-C₃₀ alkyl; C₁-C₃₀ alkoxy; —CO₂H; —CH₂COOH; —SO₃-M₁; —OSO₃-M₁; —PO₃²⁻M₁; —OPO₃²⁻M₁; and mixtures thereof;
B₃ is hydrogen; hydroxyl; —COOH; —SO₃-M₁; —OSO₃ M₁ or C₁-C₆ alkoxy;
M₁ is a water-soluble cation;
T₁ is —O—; or —NH—;
X₁ and X₄ independently of one another are —O—; —NH— or —N—C₁-C₅alkyl;
R₁₁ and R₁₂ independently of one another are hydrogen; a sulfo group and salts thereof; a carboxyl group and salts thereof or a hydroxyl group; at least one of the radicals R₁₁ and R₁₂ being a sulfo or carboxyl group or salts thereof,
Y₂ is —O—; —S—; —NH— or —N—C₁-C₅alkyl;
R₁₃ and R₁₄ independently of one another are hydrogen; C₁-C₆ alkyl; hydroxy-C₁-C₆ alkyl; cyano-C₁-C₆ alkyl; sulfo-C₁-C₆ alkyl; carboxy or halogen-C₁-C₆ alkyl; unsubstituted phenyl or phenyl substituted by halogen, C₁-C₄ alkyl or C₁-C₄ alkoxy; sulfo or carboxyl or R₁₃ and R₁₄ together with the nitrogen atom to which they are bonded form a saturated 5- or 6-membered heterocyclic ring which may additionally also contain a nitrogen or oxygen atom as a ring member;
R₁₅ and R₁₆ independently of one another are C₁-C₆ alkyl or aryl-C₁-C₆ alkyl radicals;
R₁₇ is hydrogen; an unsubstituted C₁-C₆ alkyl or C₁-C₆ alkyl substituted by halogen, hydroxyl, cyano, phenyl, carboxyl, carb-C₁-C₆ alkoxy or C₁-C₆ alkoxy;
R₁₈ is C₁-C₂₂ alkyl; branched C₃-C₂₂ alkyl; C₁-C₂₂ alkenyl or branched C₃-C₂₂ glycol; C₁-C₂₂ alkoxy; branched C₃-C₂₂ alkoxy; and mixtures thereof;
M is hydrogen; or an alkali metal ion or ammonium ion,
Z₂⁻ is a chlorine; bromine; alkylsulfate or arylsulfate ion;
a is 0 or 1;
b is from 0 to 6;
c is from 0 to 100;
d is 0; or 1;
e is from 0 to 22;
v is an integer from 2 to 12;
w is 0 or 1; and
A⁻ is an organic or inorganic anion, and
s is equal to r in cases of monovalent anions A⁻ and less than or equal to r in cases of polyvalent anions, it being necessary for Aₛ⁻ to compensate the positive charge; where, when r is not equal to 1, the radicals Q₁ can be identical or different,
   and where the phthalocyanine ring system may also comprise further solubilising groups;

Other suitable catalytic photobleaches include xanthene dyes and mixtures thereof. In another aspect, suitable catalytic photobleaches include catalytic photobleaches selected from the group consisting of sulfonated zinc phthalocyanine, sulfonated aluminium phthalocyanine, Eosin Y, Phoxine B, Rose Bengal, C.I. Food Red 14 and mixtures thereof.

Suitable photo-initiators include photo-initiators selected from the group consisting of Aromatic 1,4-quinones such as anthraquinones and naphthaquinones; Alpha amino ketones, particularly those containing a benzoyl moiety, otherwise called alpha-amino acetophenones; Alpha-hydroxy ketones, particularly alpha-hydroxy acetophenones; Phosphorus-containing photoinitiators, including monoacyl, bisacyl and trisacyl phosphine oxide and sulphides; Dialkoxy acetophenones; Alpha-haloacetophenones; Trisacyl phosphine oxides; Benzoin and benzoin based photoinitiators, and mixtures thereof. In another aspect, suitable photo-initiators include photo-initiators selected from the group consisting of 2-ethyl anthraquinone; Vitamin K3; 2-sulphate-anthraquinone; 2-methyl 1-[4-phenyl]-2-morpholinopropan-1-one (Irgacure® 907); (2-benzyl-2-dimethyl amino-1-(4-morpholinophenyl)-butan-1-one (Irgacure® 369); (1-[4-(2hydroxyethoxy)-phenyl]-2 hydroxy-2-methyl-1-propan-1-one) (Irgacure® 2959); 1-hydroxy-cyclohexyl-phenyl-ketone (Irgacure® 184); oligo[2-hydroxy 2-methyl-1-[4(1-methyl)-phenyl]propanone (Esacure® KIP 150); 2-4-6-(trimethylbenzoyl)diphenyl-phosphine oxide, bis(2,4,6-trimethylbenzoyl)-phenyl-phosphine oxide (Irgacure® 819); (2,4,6 trimethylbenzoyl)phenyl phosphinic acid ethyl ester (Lucirin® TPO-L); and mixtures thereof.

The aforementioned photobleaches can be used in combination (any mixture of photobleaches can be used). Suitable photobleaches can be purchased from Aldrich, Milwaukee, Wis., USA; Frontier Scientific, Logan, Utah, USA; Ciba Specialty Chemicals, Basel, Switzerland; BASF, Ludwigshafen, Germany; Lamberti S.p.A, Gallarate, Italy; Dayglo Color Corporation, Mumbai, India; Organic Dyestuffs Corp., East Providence, R.I., USA; and/or made in accordance with the examples contained herein.

### Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, fabric hueing agents, perfumes, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. However, when one or more adjuncts are present, such one or more adjuncts may be present as detailed below:

Bleaching Agents—The cleaning compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;

(2) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(3) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—The cleaning compositions can comprise one or more enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a cleaning composition, the aforementioned enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

### Processes of Making Compositions

The compositions of the present invention can be formulated into any suitable form and prepared by any process chosen by the formulator, non-limiting examples of which are described in Applicants' examples and in U.S. Pat. No. 4,990,280; U.S. 20030087791A1; U.S. 20030087790A1; U.S. 20050003983A1; U.S. 20040048764A1; U.S. Pat. No. 4,762,636; U.S. Pat. No. 6,291,412; U.S. 20050227891A1; EP 1070115A2; U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. 5,489,392; U.S. Pat. No. 5,486,303 all of which are incorporated herein by reference.

### Method of Use

The present invention includes a method for cleaning and/or treating a situs inter alia a surface or fabric. Such method includes the steps of contacting an embodiment of Applicants' cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### Examples

Unless otherwise indicated, materials can be obtained from Aldrich, P.O. Box 2060, Milwaukee, Wis. 53201, USA.

### Examples 1-6

Granular laundry detergent compositions designed for handwashing or top-loading washing machines.

| | 1 | 2 | 3 | 4 | 5 | 6 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 1 | 1 | 0.6 | 0.0 | 0.7 |
| ammonium chloride | | | | | | |
| AE3S | 0.9 | 0.0 | 0.9 | 0.0 | 0.0 | 0.9 |
| AE7 | 0.0 | 0.5 | 0.0 | 1 | 3 | 1 |
| Sodium tripolyphosphate | 23 | 30 | 23 | 17 | 12 | 23 |
| Zeolite A | 0.0 | 0.0 | 0.0 | 0.0 | 10 | 0.0 |
| 1.6R Silicate (SiO₂:Na₂O at | 7 | 7 | 7 | 7 | 7 | 7 |
| ratio 1.6:1) | | | | | | |
| Sodium Carbonate | 15 | 14 | 15 | 18 | 15 | 15 |
| Polyacrylate MW 4500 | 1 | 0.0 | 1 | 1 | 1.5 | 1 |
| Carboxy Methyl Cellulose | 1 | 1 | 1 | 1 | 1 | 1 |
| Savinase ® 32.89 mg/g | 0.1 | 0.07 | 0.1 | 0.1 | 0.1 | 0.1 |
| Natalase ® 8.65 mg/g | 0.1 | 0.1 | 0.1 | 0.0 | 0.1 | 0.1 |
| Lipex ® 18 mg/g* | 0.1 | 0.07 | 0.3 | 0.1 | 0.07 | 0.4 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| Diethylenetriamine | 0.6 | 0.3 | 0.6 | 0.25 | 0.6 | 0.6 |
| pentacetic acid | | | | | | |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate | 4.4 | 0.0 | 3.85 | 2.09 | 0.78 | 3.63 |
| Monohydrate | | | | | | |
| NOBS | 1.9 | 0.0 | 1.66 | — | 0.33 | 0.75 |
| TAED | 0.58 | 1.2 | 0.51 | — | 0.015 | 0.28 |
| C.I. Food Red 14 | — | 0.025 | 0.05 | — | 0.04 | 0.03 |
| 2-Ethylanthraquinone | 0.2 | — | — | 0.3 | — | — |
| Vitamin K3 | — | — | 0.25 | — | — | 0.2 |
| Sulfate/Moisture | Balance | Balance to | Balance to | Balance | Balance | Balance |
| | to 100% | 100% | 100% | to 100% | to 100% | to 100% |

Any of the above compositions is used to launder fabrics at a concentration of 600-10,000 ppm in water, with typical median conditions of 2500 ppm, 25° C., and a 25:1 water:cloth ratio.

### Examples 7-10

Granular laundry detergent compositions designed for front-loading automatic washing machines.

| | 7 | 8 | 9 | 10 |
|---|---|---|---|---|
| | (wt %) | (wt %) | (wt %) | (wt %) |
| Linear alkylbenzenesulfonate | 8 | 7.1 | 7 | 6.5 |
| AE3S | 0 | 4.8 | 0 | 5.2 |
| Alkylsulfate | 1 | 0 | 1 | 0 |
| AE7 | 2.2 | 0 | 3.2 | 0 |
| C₁₀₋₁₂ Dimethyl | 0.75 | 0.94 | 0.98 | 0.98 |
| hydroxyethylammonium chloride | | | | |
| Crystalline layered silicate (δ- | 4.1 | 0 | 4.8 | 0 |
| Na₂Si₂O₅) | | | | |
| Zeolite A | 20 | 0 | 17 | 0 |
| Citric Acid | 3 | 5 | 3 | 4 |
| Sodium Carbonate | 15 | 20 | 14 | 20 |
| Silicate 2R (SiO₂:Na₂O at | 0.08 | 0 | 0.11 | 0 |
| ratio 2:1) | | | | |
| Soil release agent | 0.75 | 0.72 | 0.71 | 0.72 |
| Acrylic Acid/Maleic Acid | 1.1 | 3.7 | 1.0 | 3.7 |
| Copolymer | | | | |
| Carboxymethylcellulose | 0.15 | 1.4 | 0.2 | 1.4 |
| Protease (56.00 mg active/g) | 0.37 | 0.4 | 0.4 | 0.4 |
| Termamyl ® (21.55 mg active/g) | 0.3 | 0.3 | 0.3 | 0.3 |
| Lipex ® (18.00 mg active/g) | 0.05 | 0.15 | 0.1 | 0.5 |
| Natalase ® (8.65 mg active/g) | 0.1 | 0.14 | 0.14 | 0.3 |
| TAED | 3.6 | 4.0 | 3.6 | 4.0 |
| Percarbonate | 13 | 13.2 | 13 | 13.2 |
| Na salt of Ethylenediamine-N,N′- | 0.2 | 0.2 | 0.2 | 0.2 |
| disuccinic acid, (S,S) isomer | | | | |
| (EDDS) | | | | |
| Hydroxyethane di phosphonate | 0.2 | 0.2 | 0.2 | 0.2 |
| (HEDP) | | | | |
| MgSO₄ | 0.42 | 0.42 | 0.42 | 0.42 |
| Perfume | 0.5 | 0.6 | 0.5 | 0.6 |
| Suds suppressor agglomerate | 0.05 | 0.1 | 0.05 | 0.1 |
| Soap | 0.45 | 0.45 | 0.45 | 0.45 |
| Sodium sulfate | 22 | 33 | 24 | 30 |
| C.I. Food Red 14 | — | — | 0.02 | — |
| 2-Ethylanthraquinone | 0.2 | — | — | 0.05 |
| Vitamin K3 | — | 0.07 | — | 0.1 |
| Water & Miscellaneous | Balance | Balance | Balance | Balance |
| | to 100% | to 100% | to | to |
| | | | 100% | 100% |

Any of the above compositions is used to launder fabrics at a concentration of 10,000 ppm in water, 20-90° C., and a 5:1 water:cloth ratio. The typical pH is about 10.

### Examples 11-16

### Heavy Duty Liquid Laundry Detergent Compositions

| | | | 13 | 14 | 15 | 16 |
|---|---|---|---|---|---|---|
| | 11 (wt %) | 12 (wt %) | (wt %) | (wt %) | (wt %) | (wt %) |
| AES C₁₂₋₁₅ alkyl | 11 | 10 | 4 | 6.32 | 6.0 | 8.2 |
| ethoxy (1.8) | | | | | | |
| sulfate | | | | | | |
| Linear alkyl | 4 | 0 | 8 | 3.3 | 4.0 | 3.0 |
| benzene sulfonate | | | | | | |
| HSAS | 0 | 5.1 | 3 | 0 | 2 | 0 |
| Sodium formate | 1.6 | 0.09 | 1.2 | 0.04 | 1.6 | 1.2 |
| Sodium hydroxide | 2.3 | 3.8 | 1.7 | 1.9 | 2.3 | 1.7 |
| Monoethanolamine | 1.4 | 1.490 | 1.0 | 0.7 | 1.35 | 1.0 |
| Diethylene glycol | 5.5 | 0.0 | 4.1 | 0.0 | 5.500 | 4.1 |
| Nonionic | 0.4 | 0.6 | 0.3 | 0.3 | 2 | 0.3 |
| Chelant | 0.15 | 0.15 | 0.11 | 0.07 | 0.15 | 0.11 |
| Citric Acid | 2.5 | 3.96 | 1.88 | 1.98 | 2.5 | 1.88 |
| C₁₂₋₁₄ dimethyl | 0.3 | 0.73 | 0.23 | 0.37 | 0.3 | 0.225 |
| Amine Oxide | | | | | | |
| C₁₂₋₁₈ Fatty Acid | 0.8 | 1.9 | 0.6 | 0.99 | 0.8 | 0.6 |
| Borax | 1.43 | 1.5 | 1.1 | 0.75 | 1.43 | 1.07 |
| Ethanol | 1.54 | 1.77 | 1.15 | 0.89 | 1.54 | 1.15 |
| Ethoxylated (EO₁₅) | 0.3 | 0.33 | 0.23 | 0.17 | 0.0 | 0.0 |
| tetraethylene pentaimine¹ | | | | | | |
| Ethoxylated | 0.8 | 0.81 | 0.6 | 0.4 | 0.0 | 0.0 |
| hexamethylene | | | | | | |
| diamine² | | | | | | |
| 1,2-Propanediol | 0.0 | 6.6 | 0.0 | 3.3 | 0.0 | 0.0 |
| Protease* | 36.4 | 36.4 | 27.3 | 18.2 | 36.4 | 27.3 |
| Mannaway ®* | 1.1 | 1.1 | 0.8 | 0.6 | 1.1 | 0.8 |
| Natalase ®* | 7.3 | 7.3 | 5.5 | 3.7 | 7.3 | 5.5 |
| Lipex ®* | 10 | 3.2 | 0.5 | 3.2 | 2.4 | 3.2 |
| C.I. Food Red 14 | 0.02 | — | 0.015 | — | — | 0.02 |
| Vitamin K3 | — | 0.07 | — | 0.1 | 0.04 | 0.12 |
| Water, perfume, | Balance | Balance | Balance | Balance | Balance | Balance |
| dyes & other | | | | | | |
| components | | | | | | |

### Raw Materials and Notes for Composition Examples 1-16

Linear alkylbenzenesulfonate having an average aliphatic carbon chain length C₁₁-C₁₂ supplied by Stepan, Northfield, Ill., USA
C₁₂₋₁₄ Dimethylhydroxyethyl ammonium chloride, supplied by Clariant GmbH, Sulzbach, Germany
AE3S is C₁₂₋₁₅ alkyl ethoxy (3) sulfate supplied by Stepan, Northfield, Ill., USA
AE7 is C₁₂₋₁₅ alcohol ethoxylate, with an average degree of ethoxylation of 7, supplied by Huntsman, Salt Lake City, Utah, USA
Sodium tripolyphosphate is supplied by Rhodia, Paris, France
Zeolite A is supplied by Industrial Zeolite (UK) Ltd, Grays, Essex, UK
1.6R Silicate is supplied by Koma, Nestemica, Czech Republic
Sodium Carbonate is supplied by Solvay, Houston, Tex., USA
Polyacrylate MW 4500 is supplied by BASF, Ludwigshafen, Germany
Carboxy Methyl Cellulose is Finnfix® BDA supplied by CPKelco, Arnhem, Netherlands
Savinase®, Natalase®, Lipex®, Termamyl®, Mannaway® supplied by Novozymes, Bagsvaerd, Denmark
Fluorescent Brightener 1 is Tinopal® AMS, Fluorescent Brightener 2 is Tinopal® CBS-X,
Diethylenetriamine pentacetic acid is supplied by Dow Chemical, Midland, Mich., USA
Sodium percarbonate supplied by Solvay, Houston, Tex., USA
Sodium perborate is supplied by Degussa, Hanau, Germany
NOBS is sodium nonanoyloxybenzenesulfonate, supplied by Eastman, Batesville, Ark., USA
TAED is tetraacetylethylenediamine, supplied under the Peractive® brand name by Clariant GmbH, Sulzbach, Germany
Soil release agent is Repel-o-tex® PF, supplied by Rhodia, Paris, France
Acrylic Acid/Maleic Acid Copolymer is molecular weight 70,000 and acrylate:maleate ratio 70:30, supplied by BASF, Ludwigshafen, Germany
Protease is FN3 supplied by Genencor International, Palo Alto, Calif., USA
Na salt of Ethylenediamine-N,N′-disuccinic acid, (S,S) isomer (EDDS) is supplied by Octel, Ellesmere Port, UK
Hydroxyethane di phosphonate (HEDP) is supplied by Dow Chemical, Midland, Mich., USA
Suds suppressor agglomerate is supplied by Dow Corning, Midland, Mich., USA
HSAS is mid-branched alkyl sulfate as disclosed in U.S. Pat. No. 6,020,303 and U.S. Pat. No. 6,060,443 C₁₂₋₁₄ dimethyl Amine Oxide is supplied by Procter & Gamble Chemicals, Cincinnati, Ohio, USA
Nonionic is preferably a C₁₂-C₁₃ ethoxylate, preferably with an average degree of ethoxylation of 9.
Protease is supplied by Genencor International, Palo Alto, Calif., USA
* Numbers quoted in mg enzyme/100 g
¹ as described in U.S. Pat. No. 4,597,898.
² available under the tradename LUTENSIT® from BASF and such as those described in WO 01/05874

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising a lipase and a photobleach material selected from a xanthene dye photobleach, a photo-initiator and mixtures thereof.

2. The composition of claim 1 wherein said lipase is present at a level of from about 0.0005% to about 0.1% and said photobleach material is present at a level of from about 0.0001% to about 1%.

3. The composition of claim 1 wherein said lipase is selected from the group consisting of lipase having E.C. classification 3.1.1 and mixtures thereof, said xanthene dye photobleach is selected from the group consisting of Eosin Y, Phoxine B, Rose Bengal, C.I. Food Red 14 and mixtures thereof, and said photo-initiator is selected from the group consisting of Aromatic 1,4-quinones; Alpha amino ketones; Alpha-hydroxy ketones; Phosphorus-containing photoinitiators; Dialkoxy acetophenones; Alpha-haloacetophenones; Trisacyl phosphine oxides; benzoin based photoinitiators, and mixtures thereof.

4. The composition of claim 2 wherein said lipase is selected from the group consisting of lipase having E.C. classification 3.1.1 and mixtures thereof, said xanthene dye photobleach is selected from the group consisting of Eosin Y, Phoxine B, Rose Bengal, C.I. Food Red 14 and mixtures thereof, and said photo-initiator is selected from the group consisting of Aromatic 1,4-quinones; Alpha amino ketones; Alpha-hydroxy ketones; Phosphorus-containing photoinitiators; Dialkoxy acetophenones; Alpha-haloacetophenones; Trisacyl phosphine oxides; benzoin based photoinitiators, and mixtures thereof.

5. The composition of claim 3 wherein said lipase is selected from the group consisting of lipase having E.C. classification 3.1.1.3 and mixtures thereof, said xanthene dye photobleach comprises C.I. Food Red 14 and mixtures thereof, and said photo-initiator is selected from the group consisting of 2-ethyl anthraquinone; Vitamin K3; 2-sulphate-anthraquinone; 2-methyl 1-[4-phenyl]-2-morpholinopropan-1-one; (2-benzyl-2-dimethyl amino-1-(4-morpholinophenyl)-butan-1-one; (1-[4-(2-hydroxyethoxy)-phenyl]-2 hydroxy-2-methyl-1-propan-1-one); 1-hydroxy-cyclohexyl-phenyl-ketone; oligo[2-hydroxy 2-methyl-1-[4(1-methyl)-phenyl]propanone; 2-4-6-(trimethylbenzoyl)diphenyl-phosphine oxide, bis(2,4,6-trimethylbenzoyl)-phenyl-phosphine oxide; (2,4,6 trimethylbenzoyl)phenyl phosphinic acid ethyl ester and mixtures thereof.

6. The composition of claim 5, comprising a lipase that is a variant of SEQ ID No. 2.

7. The composition of claim 6, comprising a lipase that is a variant of SEQ ID No. 2, said variant having at least 90% homology to SEQ ID No. 2 and comprising a substitution of an electrically neutral or negatively charged amino acid with R or K at any of positions 3, 224, 229, 231 and 233.

8. The composition of claim 5, comprising a lipase that is a variant of SEQ ID No. 2 said variant having substitutions T231R and N233R.

9. The composition of claim 1 said composition comprising an adjunct material.

10. The composition of claim 1 said composition being a cleaning and/or treatment composition.

11. A process of cleaning and/or treating a surface or fabric comprising the steps of optionally washing and/or rinsing said surface or fabric, contacting said surface or fabric with the composition of claim 1, then optionally washing and/or rinsing said surface or fabric.
